(19) United States
(12) Patent Application Publication
(10) Pub. No.: US 2002/0026406 A1
(43) Pub. Date: Feb. 28, 2002

(54) Commodity selling system displaying commodity table of purchase candidates including user comment on user terminal

(76) Inventors: Hisashi Tanaka, Tokyo (JP); Katsumi Sasaki, Tokyo (JP)

Correspondence Address: McGuire Woods, Tysons Corner, 1750 Tysons Boulevard, Suite 1800, McLean, VA, 22102-4215, US

(21) Appl. No.: 09/904,662

(22) Filed: Jul. 16, 2001

(30) Foreign Application Priority Data
Jul. 17, 2000 (JP) 2000-216072

(51) Int. Cl. G06F 17/60

(52) U.S. Cl. 705/37

(57) ABSTRACT

A commodity selling system is disclosed for performing online shopping through a network such as the Internet. The commodity selling system includes a seller server. The seller server records a comment entered from a user terminal on each commodity selected as a purchase candidate from commodities appearing on a Web page as a shopping memo at an arbitrary time. The seller server adds the comment recorded as the shopping memo to a memo field in a commodity table including basic information on each purchase candidate, and displays the commodity table on the user terminal. A user refers to the comments in the memo fields and determines which commodity to purchase.

### BACKGROUND OF THE INVENTION

1. Field of the Invention

The present invention relates to a commodity selling system and method for performing online shopping through a network such as the Internet. 2. Description of the Related Art

In recent years, online shopping has come into use, in which a user can access a Web page through a network such as the Internet to purchase commodities by using the Web page.

FIG. 1 is a block diagram showing a configuration of a conventional commodity selling system. A user utilizes user terminal 30 to access Web page 15 provided by seller server 11 through network 20. On Web page 15, the user can see detailed information on many commodities. The user sees the detailed information on commodities on Web page 15 and selects some of the commodities as purchase candidates. In response to the selection of the purchase candidates by the user, seller server 11 forms a commodity table (Table 1) including each purchase candidate selected by the user and displays the commodity table on user terminal 30.

Table 1 shows an example of the commodity table of purchase candidates formed by the conventional commodity selling system. The commodity table shown as Table 1 includes basic information for each purchase candidate selected by the user such as the name, date and time at which the selection is made, and price of each commodity.

TABLE 1

| selection date | | |
|---|---|---|
| and time | name | price |
| 09/06/2000 | ◯◯◯◯ | ¥495,000 |
| 20:45:01 | | |
| 12/06/2000 | XXXX | ¥490,002 |
| 10:27:37 | | |
| 12/06/2000 | ΔΔΔΔ | ¥395,000 |
| 11:11:30 | | |

In the aforementioned conventional commodity selling system, if a number of purchase candidates are included in the commodity table, a user may forget the characteristics or the like of the purchase candidates when the user makes a final determination of which commodity to purchase. In such a case, it is necessary for the user to exert extra effort such as seeing the detailed information on each purchase candidate again in order to review the characteristic of each purchase candidate, resulting in a heavier burden put on the user.

### SUMMARY OF THE INVENTION

It is an object of the present invention to provide a commodity selling system and method capable of reducing a burden on a user when the user makes a final determination of which commodity to purchase from purchase candidates.

To achieve the aforementioned object, the commodity selling system according to the present invention comprises user terminals , each used by a user for connection to a network, and a seller server for recording a comment entered from the user terminal on each purchase candidate selected from commodities appearing on a Web page accessible from the user terminal through the network as a shopping memo at an arbitrary time.

In the commodity selling system of the present invention, when basic information on each purchase candidate is displayed on the user terminal, the seller server also displays the comments entered from the user terminal and recorded as the shopping memos together with the basic information. Thus, a user can make a final determination of which commodity to purchase of the purchase candidates referring to the comments, and the user need not see detailed information on the purchase candidates again. As a result, it is possible to reduce a burden on the user in determining which commodity to purchase.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram showing a configuration of a conventional commodity selling system;

FIG. 2 is a block diagram showing a configuration of a commodity selling system according to an embodiment of the present invention; and

FIG. 3 shows a commodity selling sequence in the commodity selling systems.

### DETAILED DESCRIPTION OF THE PREFERRED EMBODIMENT

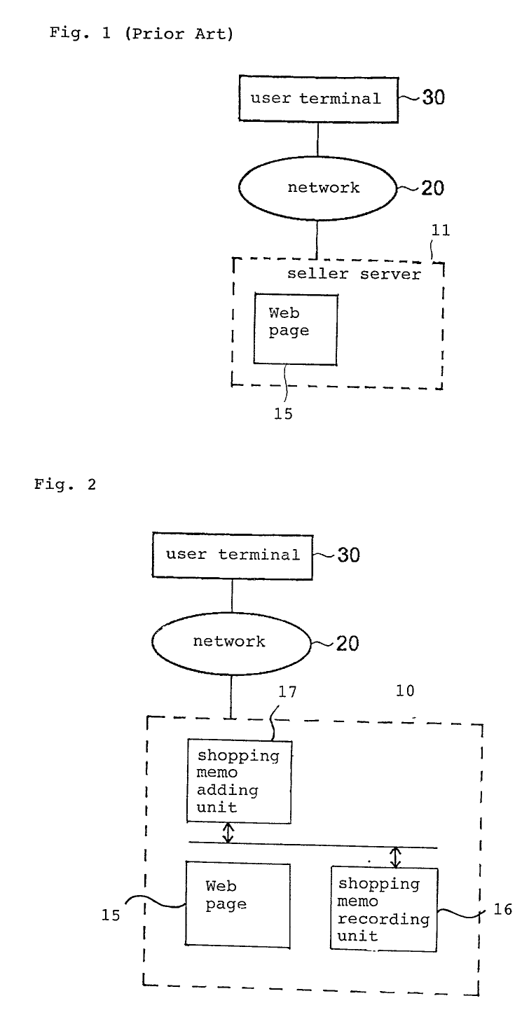

Referring now to FIG. 2, a commodity selling system according to an embodiment of the present invention differs from the conventional commodity selling system in FIG. 1 in that it comprises seller server 10 instead of seller server 11. When a user selects some commodities as purchase candidates, seller server 10 operates similarly to seller server 11, to form a commodity table including basic information on each purchase candidate. In addition, seller server 10 comprises shopping memo recording unit 16 and shopping memo adding unit 17. Shopping memo recording unit 16 and shopping memo adding unit 17 are connected to each other through an internal bus.

Shopping memo recording unit 16 records a comment entered from user terminal 30 on each purchase candidate selected from the commodities appearing on a Web page as a shopping memo at an arbitrary time. Shopping memo adding unit 17 adds the comment recorded as the shopping memo to the commodity table including the basic information on each purchase candidate, and displays the commodity table on user terminal 30.

Table 2 shows an example of a commodity table formed by seller server 10 in the commodity selling system of the embodiment. The commodity table of Table 2 lists commodities selected by a user. The commodity table includes basic information in tabular form such as the name, date and time at which the selection is made, and price of each purchase candidate selected by the user, similar to the commodity table in the conventional commodity selling system.

TABLE 2

| selection | | | | |
|---|---|---|---|---|
| date and | | | | comment from |
| time | name | price | memo | seller |
| 09/06/2000 | ◯◯◯◯ | ¥495,000 | rapid | out of stock |
| 20:45:01 | | | process | soon! |
| | | | speed | |
| 12/06/2000 | XXXX | ¥490,002 | first | best |
| 10:27:37 | | | candidate | recommendation |
| 12/06/2000 | ΔΔΔΔ | ¥395,000 | low price | best seller! |
| 11:11:30 | | | | |

In addition, in the commodity selling system of the embodiment, comments recorded in shopping memos by the user are displayed in memo fields of the commodity table of the purchase candidates. For example, if a commodity named “XXXX” was selected due mainly to low price, the user records a comment “low price” in a shopping memo when the user selects the commodity as a purchase candidate. Then, “low price” is displayed in the memo field for the commodity “XXXX” of the commodity table. When other commodities are selected, the user also records comments or the like on the commodities as shopping memos, and the comments recorded as the shopping memos are displayed in memo fields of the commodity table. The user makes a determination of which commodity to purchase of the purchase candidates listed on the commodity table. When the user makes such a determination of a commodity, the contents displayed in the memo fields of the commodity table serve as reference information in the determination of which commodity to purchase.

The commodity table shown as Table 2 displays comments of a seller on purchase candidates in addition to the comments entered by the user and recorded in the shopping memos. Such comments include inventory information on a commodity, for example “out of stock soon,” and schedule information on a commodity, for example “updated soon.” The comments on the commodities by the seller are utilized as valuable advice for a user to determine which commodity to purchase of the purchase candidates. Shopping memo recording unit 16 and shopping memo adding unit 17 of seller server 10 may be implemented by dedicated hardware, or may be formed of a memory and a CPU (Central Processing Unit) such that the functions thereof may be realized by loading a program for realizing the functions of the aforementioned respective units into the memory and executing the program.

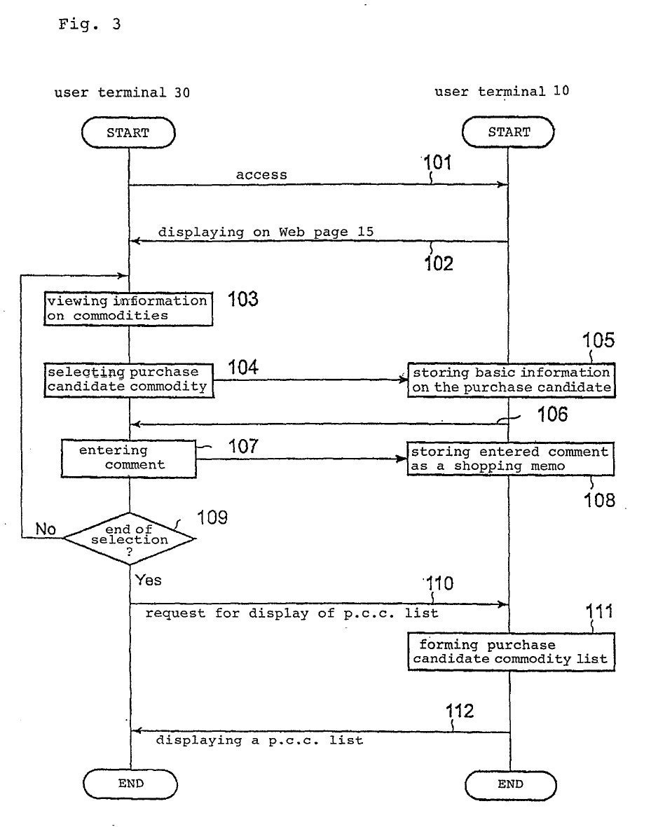

Next, the operation of the embodiment will be described with reference to FIG. 3. First, at step 101, a user accesses seller server 10 through network 20 by using user terminal 30. Then, at step 102, a Web page is displayed on user terminal 30. At step 103, the user sees detailed information on commodities appearing on the Web page, and at step 104, the user selects a purchase candidate from the commodities. Then, at step 105, seller server 10 stores basic information on the purchase candidate, and at step 106, displays on user terminal 30 a page on which the user can enter a comment on the selected commodity, that is, a shopping memo page. After the user enters a comment such as a characteristic of the selected purchase candidate at step 107, seller server 10 stores the entered comment as a shopping memo at step 108. On user terminal 30, the procedures of the aforementioned steps 103, 104, 107, and 109 is repeated until selections of all commodities are completed.

After the completion of the selections of all commodities, a request to display a commodity table of purchase candidates is transmitted from user terminal 30 at step 110. Seller server 10 forms a commodity table including the basic information on the purchase candidates and the comments recorded in the shopping memos at step 111, and displays the commodity table on user terminal 30 at step 112.

As described above, in the commodity selling system of the embodiment, when the basic information on each purchase candidate is displayed on user terminal 30, the comment entered from user terminal 30 and recorded as a shopping memo is displayed together with each item of basic information. This allows the user to make a final determination of which commodity to purchase of the purchase candidates using the comments as reference purposes , obviating the need to see the detailed information on the purchase candidates again. It is thus possible to reduce a burden on the user in determining which commodity to purchase.

In addition, in the commodity selling system of the embodiment, seller server 10 records a comment entered from user terminal 30 as a shopping memo at an arbitrary time, and in the sequence in FIG. 3, this is done each time a purchase candidate is selected. Alternatively, this may be done at the time of a quotation for a purchase candidate, the time of selection of which commodity to purchase, or the time of selection of a commodity seen by the user as purchase candidates.

While a preferred embodiment of the present invention has been described using specific terms, such description is for illustrative purposes only, and it is to be understood that changes and variations may be made without departing from the spirit or scope of the following claims.

What is claimed is:

1. A commodity selling system for enabling a user to purchase commodities through network , the systems comprising:
user terminals used ,each by a user for connection to the network; and
a seller server for recording a comment entered from said user terminal on each commodity selected as a purchase candidate from commodities appearing on a Web page accessible from said user terminal through said network as a shopping memo at an arbitrary time, and for, when displaying basic information on said each purchase candidate on said user terminal, displaying said comment recorded as said shopping memo together with said basic information.

2. The commodity selling system according to claim 1, wherein said seller server includes means for recording said comment when said each purchase candidate is quoted.

3. The commodity selling system according to claim 1, wherein said seller server includes means for recording said comment when said user determines which commodity to purchase.

4. The commodity selling system according to claim 1, wherein seller server includes means for recording said comment when said user has selected one of commodities seen by said user as a purchase candidate.

5. The commodity selling system according to claim 1, wherein said seller server includes means for displaying, when displaying said basic information is on said user terminal, a comment of a seller on said each purchase candidate together with said basic information.

6. The commodity selling system according to claim 5, wherein said seller server includes means for recording said comment when said each purchase candidate is quoted.

7. The commodity selling system according to claim 5, wherein said seller server includes means for recording said comment when said user determines which commodity to purchase.

8. The commodity selling system according to claim 5, wherein seller server has means for recording said comment when said user has selected one of commodities seen by said user as a purchase candidate.

9. A seller server for use in a commodity selling system, said selling server comprising:
a Web page accessible from a user terminal through a network;
a shopping memo recording means for recording a comment entered from said user terminal on each commodity selected as a purchase candidate from commodities appearing on said Web page as a shopping memo at an arbitrary time; and
a shopping memo adding means for displaying, when basic information on said each purchase candidate is displayed on said user terminal, said comment recorded as said shopping memo together with said basic information.

10. The seller server according to claim 9, wherein said shopping memo adding means displays, when said basic information is displayed on said user terminal, a comment of a seller on said each purchase candidate together with said basic information.

11. A method of selling online a commodity appearing on a Web page of a seller server, the accessible from user terminals through a network, said method comprising the steps of:
recording a comment entered from said user terminal on each commodity selected as a purchase candidate from commodities appearing on said Web page in said seller server as a shopping memo at an arbitrary time; and
when basic information on said each purchase candidate is displayed on said user terminal, displaying said comment recorded as said shopping memo together with said basic information.

12. The method of selling a commodity according to claim 11, further comprising the step of displaying, when said basic information is displayed on said user terminal, a comment of a seller on said each purchase candidate previously stored in said seller server together with said basic information.

13. A computer program for enabling a computer to execute of selling online commodities appearing on a Web page of a seller server , the server being accessible from a user terminal through a network, said program comprising:
a first set of instructions of recording a comment entered from said user terminal on each commodity selected as a purchase candidate from commodities appearing on said Web page as a shopping memo at an arbitrary time; and
a second set of instructions of, when displaying basic information on said each purchase candidate on said user terminal, displaying on said user terminal said comment recorded as said shopping memo together with said basic information.

14. The program according to claim 13, wherein said processing further comprises displaying, when said basic information is displayed on said user terminal, a comment of a seller on said each purchase candidate previously stored in said seller server together with said basic information.
